(19) United States
(12) Patent Application Publication
(10) Pub. No.: US 2004/0179555 A1
(43) Pub. Date: Sep. 16, 2004

(54) System and method for compressing data in a communications environment

(75) Inventor: Malcolm M. Smith, Calgary (CA)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 10/387,195

(22) Filed: Mar. 11, 2003

(51) Int. Cl. H04J 3/00

(52) U.S. Cl. 370/521; 370/328

(57) ABSTRACT

A method for compressing data is provided that includes accumulating a plurality of bits associated with a communications flow and determining whether one or more of the bits correspond to a silence signal associated with a time division multiplexed (TDM) circuit that facilitates propagation of the flow. A predefined silence pattern may be communicated, in place of one or more of the bits, to a next destination when it is determined that one or more of the bits correspond to the silence signal.

### TECHNICAL FIELD OF THE INVENTION

The present invention relates in general to the field of communications and more particularly to a system and method for compressing data in a communications environment.

### BACKGROUND OF THE INVENTION

Communication systems and architecture have become increasingly important in today's society. One aspect of communications relates to maximizing bandwidth and minimizing delays associated with data and information exchanges. Some radio access network (RAN) products are focused on the transport of traffic from the cell site, where the base transceiver station is located, to the central office (CO) site, where the base station controller is located. These RAN products implement inadequate compression techniques as significant delays are generally incurred and bandwidth savings may not be realized. Such solutions may also be narrow in targeting (or operating effectively with) only certain types of data propagating along particular communication links. Additionally, most proposed solutions for effectuating proper data and information exchanges add significant overhead and cost in order to be as efficient as possible. For example, T1/E1 lines are generally expensive and should be maximized in order to achieve optimal system performance. Accordingly, the ability to provide a communications system that consumes few resources while achieving minimal delay presents a significant challenge for network designers and system administrators.

### SUMMARY OF THE INVENTION

From the foregoing, it may be appreciated by those skilled in the art that a need has arisen for an improved compression approach that optimizes data exchanges in a communications environment. In accordance with one embodiment of the present invention, a system and method for compressing data in a communications environment are provided that substantially eliminate or greatly reduce disadvantages and problems associated with convention compression techniques.

According to an embodiment of the present invention, there is provided a system for compressing data in a communications environment that includes accumulating a plurality of bits associated with a communications flow and determining whether one or more of the bits correspond to a silence signal associated with a time division multiplexed (TDM) circuit that facilitates propagation of the flow. A predefined silence pattern may be communicated, in place of one or more of the bits, to a next destination when it is determined that one or more of the bits correspond to the silence signal.

Certain embodiments of the present invention may provide a number of technical advantages. For example, according to one embodiment of the present invention, a communications approach is provided that significantly enhances bandwidth allocations for a given architecture. This is a result of a compression technique that allows data corresponding to silence on a communications link to be treated differently. The silence may be identified by an aggregation node or by a cell site router, whereby each of these elements may transmit a predefined pattern locally that corresponds to the silence. This further allows a base transceiver station and a base station controller to only receive/communicate actual data payloads and not be burdened by silence information. This may result in bandwidth savings for a given communications architecture.

Another technical advantage associated with one embodiment of the present invention relates to delay characteristics. The communications approach provided may minimize delays associated with silence and reduce costs associated with T1/E1 lines that would otherwise be needed to facilitate such data exchanges. Delays are effectively decreased as a result of a cell site router or an aggregation node being capable of generating a predefined silence pattern, instead of treating all data uniformly such that costly resources are consumed during silence communications. Certain embodiments of the present invention may enjoy some, all, or none of these advantages. Other technical advantages may be readily apparent to one skilled in the art from the following figures, description, and claims.

### BRIEF DESCRIPTION OF THE DRAWINGS

For a more complete understanding of the present invention and the advantages thereof, reference is made to the following description taken in conjunction with the accompanying drawings, wherein like reference numerals represent like parts, in which:

FIG. 1 is a simplified block diagram of a communication system for compressing data;

FIG. 2 is a simplified block diagram of an example traffic flow in the communication system;

FIG. 3 is a simplified block diagram of an example internal structure associated with either of the cell site router or the aggregation node of the communication system; and

FIG. 4 is a simplified flowchart illustrating a series of example steps associated with the communication system.

### DETAILED DESCRIPTION OF THE INVENTION

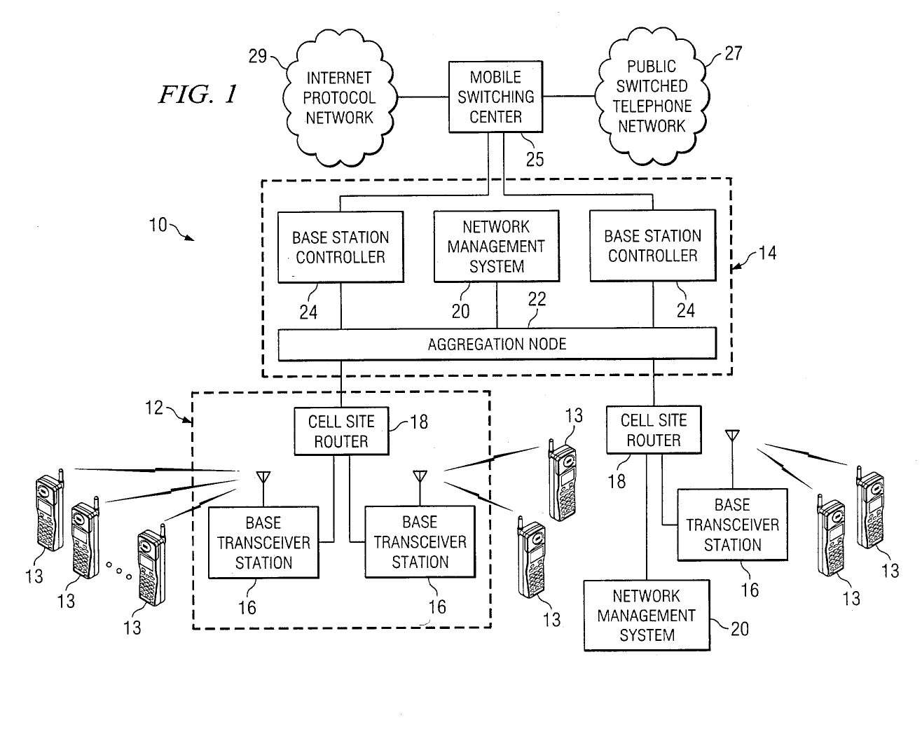

FIG. 1 is a simplified block diagram of a communication system 10 for compressing data in a communications environment. Communication system 10 may include a plurality of cell sites 12, a plurality of mobile stations 13, a central office site 14, a plurality of base transceiver stations 16, a plurality of cell site routers 18, and a network management system 20. Additionally, communication system 10 may include an aggregation node 22, a plurality of base station controllers 24, a mobile switching center 25, a public switched telephone network (PSTN) 27, and an internet protocol (IP) network 29.

Communication system 10 may generally be configured or arranged to represent a 2.5 G architecture applicable to a Global System for Mobile (GSM) environment in accordance with a particular embodiment of the present invention. However, the 2.5 G architecture is offered for purposes of example only and may alternatively be substituted with any suitable networking system or arrangement that provides a communicative platform for communication system 10. For example, the present invention may be used in conjunction with a 3 G network, where 3 G equivalent networking equipment is provided in the architecture. Communication system 10 is versatile in that it may be used in a host of communications environment such as in conjunction with any time division multiple access (TDMA) element or protocol for example, whereby signals from end users, subscriber units, or mobile stations 13 may be multiplexed over the time domain.

In accordance with the teachings of the present invention, a compression approach is provided that significantly reduces delays associated with a data exchange. Communication system 10 provides an architecture in which cell site router 18 and/or aggregation node 22 implement compression protocols in order to reduce the amount of bandwidth required for GSM data exchanges (e.g. phone calls) that may be transmitted on backhaul lines. Bits may be taken that are associated with the calls and compressed in order to reduce the T1/E1 allocations or time slots being implemented for a given number of GSM phone calls on the backhaul. An enhancement in bandwidth may be achieved because communication system 10 does not need to decode silence data. The delay, which may be generally associated with other silence compression techniques that require a decoding of silence signals, is effectively removed from the compression protocol by eliminating time intensive elements therein.

In a general sense, communication system 10 provides an architecture that allows data corresponding to silence on a communications link to be treated somewhat differently. The silence may be identified by aggregation node 22 or by cell site router 18, whereby each of these elements may transmit a predefined pattern locally that corresponds to the silence. This allows base transceiver station 16 and base station controller 24 to only receive/communicate actual data payloads and not be burdened by the processing or management of silence information. Additional details relating to cell site router 18 and aggregation node 22 are provided below with reference to FIG. 3.

The compression protocol implemented by communication system 10 may minimize delays associated with silence and reduce costs associated with T1/E1 lines that would otherwise be needed to facilitate silence data exchanges. Delays are effectively decreased as a result of cell site router 18 or aggregation node 22 being capable of generating a predefined silence pattern, instead of treating all data uniformly such that resources are consumed during silence communications. Delay may be reduced by using a packetization period on the packet switching node (PSN) that is significantly less than the packetization period of traditional compression protocols that require a packetization period at least equal to the voice codec frame period (e.g. 20 ms) in order to be compressible.

Mobile station 13 is an entity, such as a client, subscriber, end user, or customer that seeks to initiate a communication session or data exchange in communication system 10 via any suitable network. Mobile station 13 may operate to use any suitable device for communications in communication system 10. Mobile station 13 may further represent a communications interface for an end user of communication system 10. Mobile station 13 may be a cellular or other wireless telephone, an electronic notebook, a computer, a personal digital assistant (PDA), or any other device, component, or object capable of initiating a data exchange facilitated by communication system 10. Mobile station 13 may also be inclusive of any suitable interface to the human user or to a computer, such as a display, microphone, keyboard, or other terminal equipment (such as for example an interface to a personal computer or to a facsimile machine in cases where mobile station 13 is used as a modem). Mobile station 13 may alternatively be any device or object that seeks to initiate a communication on behalf of another entity or element, such as a program, a database, or any other component, device, element, or object capable of initiating a voice or a data exchange within communication system 10. Data, as used herein in this document, refers to any type of numeric, voice, video, audio-visual, or script data, or any type of source or object code, or any other suitable information in any appropriate format that may be communicated from one point to another.

Base transceiver stations 16 are communicative interfaces that may comprise radio transmission/reception devices, components, or objects, and antennas. Base transceiver stations 16 may be coupled to any communications device or element, such as mobile station 13 for example. Base transceiver stations 16 may also be coupled to base station controllers 24 (via one or more intermediate elements) that use a landline (such as a T1/E1 line, for example) interface. Base transceiver stations 16 may operate as a series of complex radio modems where appropriate. Base transceiver stations 16 may also perform transcoding and rate adaptation functions in accordance with particular needs. Transcoding and rate adaptation may also be executed in a GSM environment in suitable hardware or software (for example in a transcoding and rate adaptation unit (TRAU)) positioned between mobile switching center 25 and base station controllers 24.

In operation, communication system 10 may include multiple cell sites 12 that communicate with mobile stations 13 using base transceiver stations 16 and cell site router 18. Central office site 14 may use aggregation node 22 and base station controllers 24 for communicating with cell site 12. One or more network management systems 20 may be coupled to either cell site 12 and central office site 14 (or both as desired), whereby mobile switching center 25 provides an interface between base station controllers 24 (of central office site 14) and PSTN 27, IP network 29, and/or any other suitable communication network. Base transceiver stations 16 may be coupled to cell site router 18 by a T1/E1 line or any other suitable communication link or element operable to facilitate data exchanges. A backhaul connection between cell site router 18 and aggregation node 22 may also include a T1/E1 line or any suitable communication link where appropriate and in accordance with particular needs.

Base station controllers 24 generally operate as management components for a radio interface. This may be done through remote commands to a corresponding base transceiver station within a mobile network. One base station controller 24 may manage more than one base transceiver station 16. Some of the responsibilities of base station controllers 24 may include management of radio channels and assisting in handover scenarios.

In operation, layer one based (e.g. time division multiplexed (TDM), GSM, 8.60) or layer two based (e.g. Frame Relay, high level data link control (HDLC), asynchronous transfer mode (ATM), point to point protocol (PPP) over HDLC) traffic may be communicated by each base transceiver station 16 to cell site router 18 of cell site 12. Cell site router 18 may also receive IP or Ethernet traffic from network management system 20. Cell site router 18 may multiplex together payloads from the layer two based traffic that have a common destination. The multiplexed payloads as well as any payloads extracted from the network management system IP or Ethernet traffic may be communicated across a link to aggregation node 22 within central office site 14. Aggregation node 22 may demultiplex the payloads for delivery to an appropriate base station controller 24 or network management system 20.

Mobile switching center 25 operates as an interface between PSTN 27 and base station controllers 24, and potentially between multiple other mobile switching centers in a network and base station controller 24. Mobile switching center 25 represents a location that generally houses communication switches and computers and ensures that its cell sites in a given geographical area are properly connected. Cell sites refer generally to the transmission and reception equipment or components that connect elements such mobile station 13 to a network, such as IP network 29 for example. By controlling transmission power and radio frequencies, mobile switching center 25 may monitor the movement and the transfer of a wireless communication from one cell to another cell and from one frequency or channel to another frequency or channel. In a given communication environment, communication system 10 may include multiple mobile switching centers 25 that are operable to facilitate communications between base station controller 24 and PSTN 27. Mobile switching center 25 may also generally handle connection, tracking, status, billing information, and other user information for communications in a designated area.

PSTN 27 represents a worldwide telephone system that is operable to conduct communications. PSTN 27 may be any land line telephone network operable to facilitate communications between two entities, such as two persons, a person and a computer, two computers, or in any other environment in which data is exchanged for purposes of communication. According to one embodiment of the present invention, PSTN 27 operates in a wireless domain, facilitating data exchange between mobile station 13 and any other suitable entity within or external to communication system 10.

IP network 29 is a series of points or nodes of interconnected communication paths for receiving and transmitting packets of information that propagate through communication system 10. IP network 29 offers a communications interface between mobile stations 13 and any other suitable network equipment. IP network 29 may be any local area network (LAN), metropolitan area network (MAN), wide area network (WAN), wireless local area network (WLAN), or any other appropriate architectural system that facilitates communications in a network environment. IP network 29 implements a transmission control protocol/internet protocol (TCP/IP) communication language protocol in a particular embodiment of the present invention. However, IP network 29 may alternatively implement any other suitable communications protocol for transmitting and receiving data packets within communication system 10.

In operation of an example embodiment, the GSM backhaul voice compression technique of communication system 10 may utilize air-interface channel format information in order to suppress voice silence information without the need to decode the voice sample information itself, which results in low complexity and minimal delay. In an example or generic digital circuit-voice call (i.e. GSM, TDMA) offered for purposes of teaching, a given mobile station 13 and a transcoding and rate adaptation unit (e.g. an XC), which may be positioned at a corresponding base station controller, normally encode 20 ms worth of analog or 64 kb/s pulse code modulation (PCM) voice signal into a single digital voice frame consisting of approximately 320 bits. As a voice signal is received by mobile station 13, it is converted into digitized voice samples and transmitted to base transceiver station 16 over the air in a 16 kb/s time-slot. Base transceiver station 16 may transfer the bits to the XC (via base station controller 24) on the backhaul using a 16 kb/s sub-rate circuit. The XC receives the entire 320 bit (over a 20 ms period) and then converts the digital voice sample into a series of 8-bit PCM voice samples destined for PSTN 27 (the same process could be executed in reverse, i.e., PSTN to mobile station 13).

In communication system 10, the above-identified process may be avoided in the following manner. Cell site router 18 (at base transceiver station 16) and/or aggregation node 22 may perform compression of the 20 ms (320-bit) voice sample without applying an XC function as defined above. In this fashion, the 320-bit digital voice sample, which was transmitted over the circuit-based interface and converted to a packet representation of the voice sample, is not stored. Instead, the state of the radio channel is leveraged to determine when the air-interface is transmitting voice and when the air-interface is not transmitting. Such a power savings mode may be referred to as discontinuous transmission (or DTX) and may be a feature of GSM, code division multiple access (CDMA), wideband CDMA (WCDMA), and TDMA radio technologies.

The DTX feature may also be defined in terms of bit representation on the circuit-backhaul and, thus, no signaling from base transceiver station 16 or base station controller 24 is required in order to determine when the radio channel is in transmission and when it is not. In particular, any silence on a voice channel may be represented as a discrete bit pattern on the back-haul that is easily discernible from non-active states. The DTX state can be entered and exited at any time with transition speed being limited by the silence detection circuitry in mobile station 13 and/or the XC. However, the DTX state generally cannot transition during a 20 ms digitized voice sample period and so silence occurs in 20 ms intervals.

A simplistic approach to such communication scenarios may be to simply wait for the 320 bits to arrive from base transceiver station 16/base station controller 24 and to code the received DTX state accordingly within a packet format. However, such an approach would add significant delay to the transport process. Instead, communication system 10 may break down the 320-bit frame into multiple sub-frames (e.g. 20 16-bit sub-frames). Each sub-frame may be transferred from cell site router 18 at base transceiver station 16 to aggregation node 22 at base station controller 24 via a low delay packet backhaul, whereby the received sub-frame is played out to the XC with an appropriate jitter buffer. An algorithm may then read each sub-frame from the packet interface (from cell site router 18 or aggregation node 22) as raw data, inject the DTX state (suppressing silence), and then play out the sub-frame in sequence with other sub-frames to the circuit interface. This may be executed while not needing to interpret the sub-frame content. Such an approach may offer enhanced bandwidth allocations via silence suppression while reducing the delay and complexity of the compression protocol.

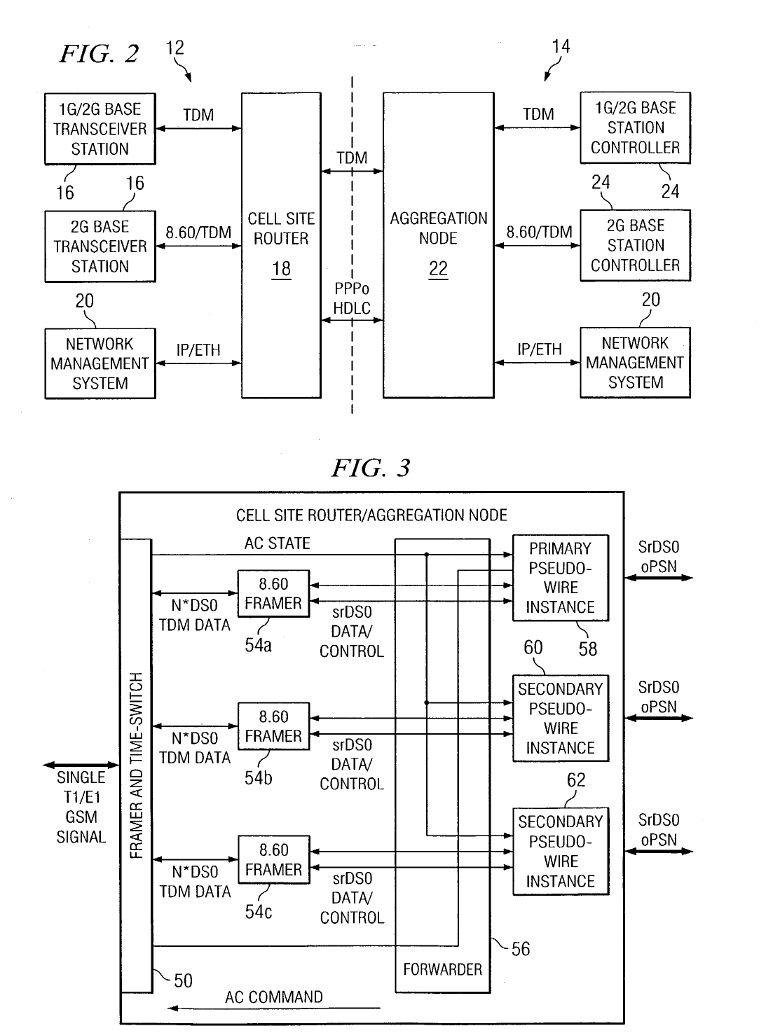

FIG. 2 shows an example traffic flow in communications system 10. For discussion purposes only, a specific layer one based approach implementing a 8.60/TDM protocol is presented. However, other types of layer one or two based protocols may be used herein with equal effectiveness. The transport of the sub-frames over the packet back-haul can be layer two based architecture, but also could be any other suitable layer based implementation such as a layer four based implementation as described in the TDMoIP variant of the transport protocol. The layer two based approach is a compression scheme that allows existing packet based backhaul transport protocols to be integrated with (and efficiently carried over) an IP based backhaul transport mechanism. In a simplest case, offered for purposes of example only, the source link (e.g. T1) contains GSM 8.60 frames containing voice, data, control, or O&M traffic. A corresponding aggregation node 22 or cell site router 18 may ignore inter-frame fill, search for and synchronize to the 8.60 frame header (e.g. sixteen consecutive 1s), suppress IDLE (or non-active) voice/data frames, and pass the payload frame (i.e. non-IDLE voice/data, control, O&M) to the high level data link control (HDLC)mux stack for multiplexing with other frames destined from the same destination link. In the upstream direction from mobile station 13, the compression scheme may include several trunk source links from base transceiver stations 16 to cell site router 18. Payloads from traffic carried on the trunk source links may be extracted, compressed, and multiplexed by cell site router 18 and placed into a PPP packet for transport to aggregation node 22. Aggregation node 22 may extract individual payloads from the PPP packet for distribution to the appropriate base station controller 24. In the downstream direction to mobile station 13, the compression scheme works in a similar manner as aggregation node 22 and cell site router 18 include appropriate protocol stacks to process payloads.

In a typical cellular system, 60% of a two-way voice conversation may be attributed to silence. When the voice coder of mobile station 13 and the XC of base station controller 24 detect silence, each may communicate IDLE (or non-active) frames (e.g. all 1s or all 0s). If the compression algorithm can suppress the IDLE (or non-active) frames, a significant savings in backhaul can be achieved. The compressor may indicate the arrival of an IDLE (or non-active) frame (e.g. frame code) and the decompressor may regenerate the IDLE (or non-active) frame when it is expected (e.g. 20 ms interval) without transmission of the actual bits on the back-haul. The compressor may not be capable of waiting an entire 20 ms (320 bit) frame time before outputting an IDLE (or non-active) frame (e.g. given a 5 ms delay budget) and, thus, sub-frame compression may be used (e.g. 320 bits broken down into 4×80-bit sub-frames). These sub-frames (voice, data, control, O&M, implied IDLE (or non-active) frame, etc.) may be regenerated by the decompressor in the correct sequence to ensure circuit emulation behavior.

In a sub-rate digital signaling zero (DSO) channel, an 8-bit time-slot may be divided into sub-slots (i.e. 2-bits for 16 kb/s, 1-bit for 8 kb/s, etc.) and the sub-rate channel may be used to carry a GSM 8.60 voice sample, data frame, control frame, or O&M frame (i.e. 320 bits every 20 ms). Frame synchronization may be built onto each sub-rate channel (e.g. 16 consecutive 0s, 0 every 16th bit) delineating voice and data frames from control/O&M frames as well as from each other and other frame types.

In addition, propagation delay and time synchronization procedures (PATE) may be used to adjust the sub-rate channel frame alignment in order to make sure that the frames arrive from base station controller 24 and base transceiver station 16 in time for over-the-air transmission and PSTN clocking respectively. This means the system may behave like a TDM circuit by adding a constant amount of delay to the frame during compression/decompression (i.e. 0 jitter). In addition, it may also be appropriate to align the frames with a TDM reference (e.g. bit 0 of frame aligned with bit 0 of slot x).

Communication system 10 may include a compression approach that relies on the use of pseudo-wire emulation (PWE) [i.e. circuit-emulation services (CES)] for the transport of frames across a backhaul link. In such an approach, there may be only one hop (point-to-point) and therefore network delay/jitter can be controlled. The ‘TDMmux’ compression approach may use CES for sampling, transport, and replay of TDM samples in an example embodiment of the present invention. Once sampled, GSM 8.60 specific payload compression may be applied in order to reduce required transport network bandwidth. In a 2 G environment, the TDM traffic may be given higher priority over other traffic sources that are presumed to be non real-time management/control traffic. For example, 8.60 payloads may be given a higher priority over other types of payloads. 8.60 payloads may tend to carry voice traffic, while other types of payloads are presumed to carry non-real time management and control information.

FIG. 3 is a simplified block diagram of either aggregation node 22 or cell site router 18 in accordance with an example embodiment of the present invention. It is critical to note that the use of the terms ‘aggregation node’ and ‘cell site router’ herein in this document only connotes an example representation of one or more elements associated with base transceiver station 16 and base station controller 24. These terms have been offered for purposes of example and teaching only and do not necessarily imply any particular architecture or configuration. Moreover, the terms ‘cell site router’ (which may also be referred to more generically as a ‘cell site element’) and ‘aggregation node’ are intended to encompass any network element operable to facilitate a data exchange in a network environment. Accordingly, cell site router 18 and aggregation node 22 may be routers, switches, bridges, gateways, interfaces, or any other suitable module, device, component, element or object operable to effectuate one or more of the operations, tasks, or functionalities associated with compressing data as implied, described, or offered herein.

Each aggregation node 22 or cell site router 18 may include a framer and time-switch element 50, multiple 8.60 framers 54a-c, a forwarder 56, a primary instance 58, and secondary instances 60 and 62. Each of aggregation node 22 and cell site router 18 may perform similar compression and data management techniques. Each of these elements may also include any suitable hardware, software, object, or element operable to execute one or more of their functionalities. Additionally, such elements may be inclusive of suitable algorithms that operate to distribute data properly in a communications environment. For example, appropriate algorithms and software may be used in order to identify the type of signal (or information associated with the signal or link) being communicated between base transceiver station 18 and base station controller 24.

Emulation may be provided for standard TDM signals. Cell site router 18 or aggregation node 22 may terminate the attachment circuit (AC) that, in an example embodiment, is a structured T1/E1 link that complies with GSM 8.60 framing. The pseudo wire (PW) is a logical construct that takes the sub-rate (sr) DSO data/control stream and transports it over a corresponding packet switch node or network (PSN). Each of primary instance 58, and secondary instances 60 and 62 may provide 8.60 specific payload compression (e.g. elimination of voice IDLE frames) before transmission over the PSN. Multiple streams may be multiplexed onto one transport payload.

Aggregation node 22 or cell site router 18 may separate a GSM signal at framer 50 such that it is broken into multiple DSO (64k-bit channels). 8.60 framers 54a-c may then break down individual time slots. 8.60 framers 54a-c may be application specific integrated circuits (ASICs), digital signal processors (DSPs), or any other component, device, hardware, software, element or object operable to execute one or more operations designated to framer 50. Forwarder 56 may then associate a separate channel (both data and bearer information) to a selected primary or secondary instance 58, 60, or 62. Forwarder 56 may also distribute common control signals for the GSM architecture. Primary instance 58 and secondary instances 60 and 62 may include software or hardware that captures bearer bits and performs compression or silence suppression. These elements may then produce an IP packet that contains compressed bearer bits. That packet may be forwarded up to a PSN, which may be inclusive of T1/E1 lines.

Each of aggregation node 22 and cell site router 18 may include suitable algorithms in order to perform compression. The algorithms may be formulated to target a bit pattern such that when it is identified as being transmitted, it may be replaced with nothing. Even though silence is detected by a given element at base station controller 24, something must be generally transmitted on a TDM stream. For example, all 1s or all 0s may be transmitted. The TDM circuit (which is synchronous) may be terminated and converted into an asynchronous circuit using IP packets, whereby IDLE (or non-active) bits are replaced with no packets. Accordingly, it is unnecessary to transmit a packet when base transceiver station 16 or base station controller 24 is transmitting an IDLE (or non-active) sequence on the TDM circuit.

In operation of the PW-bound direction, framer 50 may deliver a set of ‘N’ DSOs as a contiguous bit-stream to a selected 8.60 framer 54a-c. Framer 50 may detect signals as defined by the particular AC and report this to forwarder 56. The selected 8.60 framer 54a-c may then break each DSO stream into ‘M’ sub-rate DSO bit-streams and deliver them to a selected primary or secondary instance 58, 60, 62. It may also detect srDSO signals (defined as 8.60 signals) and pass these to the selected instance 58, 60, or 62 over the same multiplexed data/control path. When certain signal conditions exist on the srDSO, null data may be sent to the selected instance 58, 60, or 62 by framer 50. The selected instance 58, 60, 62 may encapsulate the srDSO data/control over a PSN protocol stack.

In operation in the opposite direction, the selected instance 58, 60, or 62 may take the payload and deliver it to a selected 8.60 framer 54a-c over the same multiplexed data/control path. When no payloads are present, null data may be sent to the selected 8.60 framer 54a-c. The selected 8.60 framer 54a-c may insert the data onto the DSO stream along with other srDSO streams. If needed, the selected 8.60 framer 54a-c may translate a control signal from the selected instance 58, 60, 62 (either self-generated or from a peer instance) into a bit-pattern (e.g. IDLE). Framer 50 may take the DSOs and transmit them on the AC path, inserting signals under command from the AC command stream (e.g. AIS on a T-1).

Forwarder 50 is responsible for connecting the data and control streams of the selected 8.60 framer 54a-c to the appropriate instance (and providing a PW identifier to each stream). Each instance 58, 60, and 62 is connected to the AC state signal that is used for relaying data to peers and for suppressing data. For each AC, primary instance 58 is allocated (e.g. via provisioning), which in addition to receiving the AC signal, can control the AC. Commands for the AC may be either self-generated by primary instance 58 or be received from a peer instance. Similarly, if any remote instance receives an error signal from their remotely attached AC, the local primary instance may also generate an alarm condition on the AC by using the command interface. Putting the AC in some alarm state has the effect of disabling framer 50 (and hence TDM data is discarded). This local state change may be reflected in the AC signal state, which may be reflected back to selected instances and reported to remote peers.

In operation, the GSM 8.60 protocol may allow for base transceiver station 16 and base station controller 24 to adjust the 320-bit 20 ms frame to account for air-link clock, PSTN clock, and propagation delay considerations. These procedures are, in general, initiated and controlled by the RAN equipment and the transport network may not be involved in the procedure. In order to minimize the need for these procedures, the jitter of the network may be set as low as possible (ideally zero). This may be important because base transceiver station 16 and base station controller 24 assume the circuit (i.e. emulated by the transport network) is symmetric and any delay is merely signal propagation and switching delay.

In the architecture provided by communication system 10, the selected 8.60 framer 54a-c may perform compression automatically in the form of invalid frame suppression. When IDLE (or non-active) or error patterns are present on the ingress stream, no TDM data may be sent to the PW compressor and no protocol data units (PDUs) are generated. Under these conditions, an srDSO that is provisioned on the de-compressor nay generate the error pattern. This, in itself, saves bandwidth for channels that are provisioned but that have not been allocated to calls. When a valid frame is detected, TDM data may be transferred to the selected instance 58, 60, or 62 until frame synchronization is lost. During an uncompressed mode all valid bits may be encapsulated according to the data payload format and passed to a selected peer instance 58, 60, or 62 for synchronous playback. In this mode, bits (including synchronization bits and IDLE voice bits) may be transmitted and replayed.

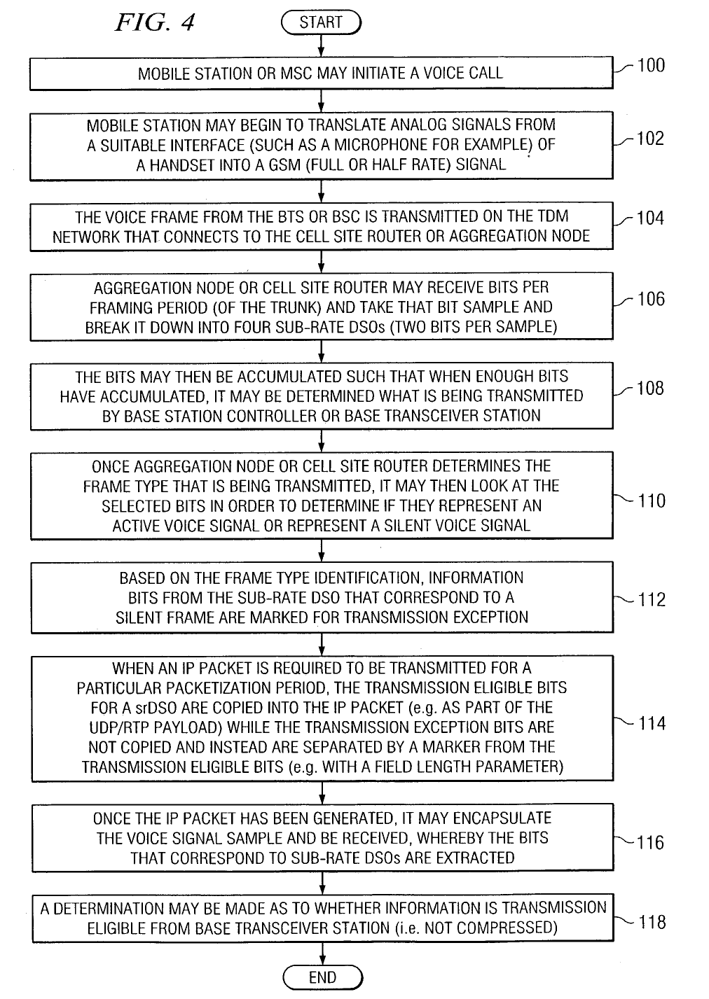

FIG. 4 is a simplified flowchart illustrating a series of example steps associated with a method for compressing voice data in a communications environment. The method may begin at step 100 where mobile station 13 or MSC 25 may initiate a voice call. These two elements may negotiate a time slot or DSO within the backhaul between base transceiver station 16 and base station controller 24. These elements may then be assigned for that particular voice call. At step 102, mobile station 13 may begin to translate analog signals from a suitable interface (such as a microphone for example) of a handset into a GSM (full or half rate) signal. This is a digital representation of the voice data that may be effectuated in a 20 ms period, which represents the packetization period of the system. (Note that the packetization period of the GSM system (20 ms) is different from the packetization period of the transport/compression/decompresion system or “frame period,” which has a much lower packetization period (e.g. 5 ms). The elements may be viewed as the GSM voice packetization period and the transport packetization period respectively.) This may be done by mobile station 13 in cooperation with a transcoder. At step 104, the voice frame from base station controller 24 or base transceiver station 16 is transmitted on the TDM network that connects to cell site router 18 or aggregation node 22.

Three hundred twenty bits may represent a single voice sample in the example provided. The bits may be transmitted by base transceiver station 16 or base station controller 24 on a TDM circuit in a separate DSO. At step 106, aggregation node 22 or cell site router 18 may receive bits per framing period (of the trunk) and take that bit sample and break it down into four sub-rate DSOs [srDSOs] (two bits per sample). These bits may then be systematically received such that when enough bits have accumulated (such value being configurable) it may be determined what is being transmitted by base station controller 24 or base transceiver station 16 at step 108. For example, it may be determined that the signal is half-rate or full-rate. Aggregation node 22 or cell site router 18 may also glean some data or control information, or whether the signal represents a silent or IDLE (or non-active) voice signal being transmitted. This may be executed by an algorithm or suitable software provided within aggregation node 22 or cell site router 18.

Aggregation node 22 or cell site router 18 may determine the frame type that is being transmitted, it may then look at the selected bits in order to determine if they represent an active voice signal or are a silent voice signal at step 110. Based on the frame type identification, information bits (non-control, non-management, etc) from the srDSO that correspond to a silent frame are marked for transmission exception. Information bits from the srDSO that correspond to a non-silent frame are marked transmission eligible, at step 112. When an IP packet is required to be transmitted for a particular packetization period, the transmission eligible bits for a srDSO are copied into the IP packet (e.g. as part of the user datagram protocol (UDP)/real time transport protocol (RTP) payload) while the transmission exception bits are not copied and instead are separated by a marker from the transmission eligible bits (e.g. with a field length parameter), at step 114 nothing may be transmitted for that particular sub-rate DSO (during the packetization period). This is the packetization period for either aggregation node 22 or cell site router 18 and not the system. Thus, this packetization period may be smaller than 20 ms. This provides for a reduction in delay equivalent to the difference between the GSM voice packetization period and the transport packetization period (in the range of 15 ms in an example embodiment).

Once the IP packet has been generated, it may encapsulate the voice signal sample. The IP packet may then be received, whereby the bits that correspond to sub-rate DSOs are extracted at step 116. The bits may then be communicated or relayed onto TDM circuit going to base station controller 24. A determination may be made as to whether information is transmission eligible from base transceiver station 16 (i.e. not compressed) at step 118. If there is an indication of no voice sample, then a corresponding decompressor may play out a predefined silence bit pattern for the circuit. This recreates the original signal from base transceiver station 16 in a way that allows the silence to be created locally by a decompressor. Accordingly, a default silent pattern may be played out allowing only some of the bits of a signal to be actually transmitted from base transceiver station 16 to base station controller 24. In this sense, only active voice traffic is communicated along the backhaul removing the burden of transmitting silence signals. This allows for increased capacity within communication system 10 in accommodating more calls and providing greater bandwidth.

Some of the steps illustrated in FIG. 4 may be changed or deleted where appropriate and additional steps may also be added to the flowchart. These changes may be based on specific communication system architectures or particular networking arrangements or configurations and do not depart from the scope or the teachings of the present invention.

Although the present invention has been described in detail with reference to particular embodiments illustrated in FIGS. 1 through 4, it should be understood that various other changes, substitutions, and alterations may be made hereto without departing from the spirit and scope of the present invention. For example, although the present invention has been described with reference to a number of elements included within communication system 10, these elements may be rearranged or positioned in order to accommodate any suitable routing architectures. In addition, any of these elements may be provided as separate external components to communication system 10 or to each other where appropriate. The present invention contemplates great flexibility in the arrangement of these elements as well as their internal components.

In addition, although the preceding description offers a compression protocol to be implemented with particular devices (e.g. aggregation node 22 and cell site router 18), the compression protocol provided may be embodied in a fabricated module that is designed specifically for effectuating the compression techniques as provided above. Moreover, such a module may be compatible with any appropriate protocol other than the 8.60 platform, which was offered for purposes of teaching and example only.

Additionally, although numerous example embodiments provided above reference voice data, communication system 10 may cooperate with any other type of data in which compression protocols are applicable. For example, normative or standard data, video data, and audio-visual data may benefit from the teachings of the present invention. Communication system 10 provides considerable adaptability in that it may be used in conjunction with any information that is sought to be compressed in a communications environment.

Numerous other changes, substitutions, variations, alterations, and modifications may be ascertained by those skilled in the art and it is intended that the present invention encompass all such changes, substitutions, variations, alterations, and modifications as falling within the spirit and scope of the appended claims. Moreover, the present invention is not intended to be limited in any way by any statement in the specification that is not otherwise reflected in the appended claims.

What is claimed is:

1. An apparatus for compressing data, comprising:
an aggregation node associated with a base station controller and operable to accumulate a plurality of bits associated with a communications flow, the aggregation node being operable to determine whether one or more of the bits correspond to a silence signal associated with a time division multiplexed (TDM) circuit that facilitates propagation of the flow, wherein the aggregation node is further operable to communicate a predefined silence pattern in place of one or more of the bits to a next destination when it is determined that one or more of the bits correspond to the silence signal.

2. The apparatus of claim 1, further comprising:
a cell site element associated with a base transceiver station and operable to receive the predefined silence pattern from the aggregation node, the cell site element being further operable to accumulate a plurality of bits associated with an additional communications flow, the cell site element operable to determine whether one or more of the bits of the additional communications flow correspond to a silence signal associated with the TDM circuit that facilitates propagation of the additional communications flow, the cell site element being further operable to communicate the predefined silence pattern in place of one or more of the bits of the additional communications flow to a next destination when it is determined that one or more of the bits of the additional communications flow correspond to the silence signal.

3. The apparatus of claim 1, wherein the aggregation node further includes a framer operable to separate a global system for mobile (GSM) signal corresponding to the flow such that the GSM signal is broken into multiple digital signaling zero (DSO) segments.

4. The apparatus of claim 1, wherein the aggregation node further comprises an 8.60 framer operable to receive a selected DSO segment from the flow and to identify whether the segment represents silence data.

5. The apparatus of claim 1, wherein the aggregation node further comprises an algorithm operable to execute compression on one or more of the bits of the flow, and wherein the algorithm is further operable to terminate the TDM circuit corresponding to the silence signal and to convert the TDM circuit to an asynchronous circuit using one or more internet protocol (IP) packets.

6. The apparatus of claim 1, wherein the silence signal corresponds to idle bits, and wherein the idle bits are replaced with no packets such that packets are not transmitted when idle sequence bits are being communicated on the TDM circuit.

7. An apparatus for compressing data, comprising:
a cell site element associated with a base transceiver station and operable to accumulate a plurality of bits associated with a communications flow, the cell site element operable to determine whether one or more of the bits of the communications flow correspond to a silence signal associated with a time division multiplexed (TDM) circuit that facilitates propagation of the communications flow, the cell site element being further operable to communicate a predefined silence pattern in place of one or more of the bits of the communications flow to a next destination when it is determined that one or more of the bits of the communications flow correspond to the silence signal.

8. The apparatus of claim 7, wherein the cell site element further includes a framer operable to separate a global system for mobile (GSM) signal corresponding to the flow such that the GSM signal is broken into multiple digital signaling zero (DSO) segments.

9. The apparatus of claim 7, wherein the cell site element further comprises an 8.60 framer operable to receive a selected DSO segment from the flow and to identify whether the segment represents silence data.

10. The apparatus of claim 7, wherein the cell site element further comprises an algorithm operable to execute compression on one or more of the bits of the flow, and wherein the algorithm is further operable to terminate the TDM circuit corresponding to the silence signal and to convert the TDM circuit to an asynchronous circuit using one or more internet protocol (IP) packets.

11. The apparatus of claim 7, wherein the silence signal corresponds to idle bits, and wherein the idle bits are replaced with no packets such that packets are not transmitted when idle sequence bits are being communicated on the TDM circuit.

12. A method for compressing data, comprising:
accumulating a plurality of bits associated with a communications flow;
determining whether one or more of the bits correspond to a silence signal associated with a time division multiplexed (TDM) circuit that facilitates propagation of the flow; and
communicating a predefined silence pattern, in place of one or more of the bits, to a next destination when it is determined that one or more of the bits correspond to the silence signal.

13. The method of claim 12, further comprising:
receiving the predefined silence pattern at the next destination; and
identifying that the predefined silence pattern corresponds to a silence signal and that the predefined silence pattern was communicated locally.

14. The method of claim 12, further comprising:
separating a global system for mobile (GSM) signal corresponding to the flow such that the GSM signal is broken into multiple digital signaling zero (DSO) segments.

15. The method of claim 12, further comprising:
executing compression on one or more of the bits of the flow;
terminating the TDM circuit corresponding to the silence signal; and
converting the TDM circuit to an asynchronous circuit using one or more internet protocol (IP) packets.

16. The method of claim 12, further comprising:
replacing one or more idle bits that correspond to the silence signal with no packets such that packets are not transmitted when idle sequence bits are being communicated on the TDM circuit.

17. A system for compressing data, comprising:
means for accumulating a plurality of bits associated with a communications flow;
means for determining whether one or more of the bits correspond to a silence signal associated with a time division multiplexed (TDM) circuit that facilitates propagation of the flow; and
means for communicating a predefined silence pattern, in place of one or more of the bits, to a next destination when it is determined that one or more of the bits correspond to the silence signal.

18. The system of claim 17, further comprising:
means for receiving the predefined silence pattern at the next destination; and
means for identifying that the predefined silence pattern corresponds to a silence signal and that the predefined silence pattern was communicated locally.

19. The system of claim 17, further comprising:
means for separating a global system for mobile (GSM) signal corresponding to the flow such that the GSM signal is broken into multiple digital signaling zero (DSO) segments.

20. The system of claim 17, further comprising:
means for executing compression on one or more of the bits of the flow;
means for terminating the TDM circuit corresponding to the silence signal; and
means for converting the TDM circuit to an asynchronous circuit using one or more internet protocol (IP) packets.

21. The system of claim 17, further comprising:
means for replacing one or more idle bits that correspond to the silence signal with no packets such that packets are not transmitted when idle sequence bits are being communicated on the TDM circuit.

22. Software embodied in a computer readable medium, the computer readable medium comprising code operable to:
accumulate a plurality of bits associated with a communications flow;
determine whether one or more of the bits correspond to a silence signal associated with a time division multiplexed (TDM) circuit that facilitates propagation of the flow; and
communicate a predefined silence pattern, in place of one or more of the bits, to a next destination when it is determined that one or more of the bits correspond to the silence signal.

23. The medium of claim 22, wherein the code is further operable to:
receive the predefined silence pattern at the next destination; and
identify that the predefined silence pattern corresponds to a silence signal and that the predefined silence pattern was communicated locally.

24. The medium of claim 22, wherein the code is further operable to:
separate a global system for mobile (GSM) signal corresponding to the flow such that the GSM signal is broken into multiple digital signaling zero (DSO) segments.

25. The medium of claim 22, wherein the code is further operable to:
execute compression on one or more of the bits of the flow;
terminate the TDM circuit corresponding to the silence signal; and
convert the TDM circuit to an asynchronous circuit using one or more internet protocol (IP) packets.
